(19) United States
(12) Patent Application Publication
(10) Pub. No.: US 2024/0086312 A1
(43) Pub. Date: Mar. 14, 2024

(54) MEMORY SEARCHING DEVICE AND METHOD

(71) Applicant: NEUCHIPS CORPORATION, Hsinchu City (TW)

(72) Inventors: Huang-Chih Kuo, Hsinchu City (TW); Youn-Long Lin, Hsinchu County (TW)

(73) Assignee: NEUCHIPS CORPORATION, Hsinchu City (TW)

(21) Appl. No.: 17/970,545

(22) Filed: Oct. 20, 2022

(30) Foreign Application Priority Data
Sep. 13, 2022 (TW) 111134570

(51) Int. Cl. G06F 12/02

(52) U.S. Cl. CPC G06F 12/0207

(57) ABSTRACT

The invention provides a memory searching device and method. The memory searching device includes a memory, a lookup command processing circuit, and a lookup result processing circuit. The lookup command processing circuit reorders an original order of lookup commands in an original lookup command string into a new order based on an accessing characteristic of the memory, and provides a reordered lookup command string to the memory. The lookup result processing circuit is coupled to the memory to receive a lookup result string, and coupled to the lookup command processing circuit to receive mapping information between the original order and the new order. The lookup result string includes lookup results corresponding to the lookup commands of the reordered lookup command string. The lookup result processing circuit restores an order of the lookup results to the original order based on the mapping information.

### CROSS-REFERENCE TO RELATED APPLICATION

This application claims the priority benefit of Taiwanese application no. 111134570, filed on Sep. 13, 2022. The entirety of the above-mentioned patent application is hereby incorporated by reference herein and made a part of this specification.

### BACKGROUND OF THE INVENTION

### Field of the Invention

The invention relates to an electronic device, and more particularly, to a memory searching device and a memory searching method.

### Description of Related Art

Memory lookup is commonly used in various artificial intelligence applications, for example, in recommendation systems, natural language processing (NLP) algorithms, or other applications. Embedding techniques are widely used in various artificial intelligence applications. The principle of embedding techniques is to store several look-up tables (LUTs) in the memory, and then search the look-up tables of the memory according to input values (lookup commands) to obtain operation results (lookup results).

Different memory devices have different access characteristics. Whether the access method conforms to the characteristics of the device significantly affects computing performance. In general, the memory is searched according to the original order of the input values. However, when the original order does not conform to the device characteristics, it may cause repeated and unnecessary lookup processes. This results in extra cost when accessing the memory, which in turn leads to a poor user experience and excessive power consumption of the device.

Taking dynamic random-access memory (DRAM) as an example, the storage space of DRAM consists of rows and columns, wherein the capacity of a row is also called page size. There is one row buffer inside DRAM, and the size thereof is equal to the page size. When the DRAM controller receives one lookup command, the DRAM reads out and stores the data of an entire row to which the target data of the lookup command belongs to the row buffer, and then the DRAM reads and writes the row buffer based on the access address of the lookup command. When the target data of the next lookup command is not in the row buffer, the DRAM stores the content of the row buffer back to the corresponding row, then reads out and stores the data of another entire row to which the target data of the next lookup command belongs in the row buffer. As mentioned above, if two consecutive access addresses are in different rows, the internal DRAM requires extra time to access the row buffer (that is, closing a row and then opening another row), resulting in lower access efficiency.

It should be noted that the content of the “prior art” paragraphs is used to help understand the invention. Part of the content (or all of the content) disclosed in the “prior art” paragraphs may not be conventional techniques known to those having ordinary skill in the art. The content disclosed in the “prior art” paragraphs does not mean that the content has been known to those having ordinary skill in the art before the application of the invention.

### SUMMARY OF THE INVENTION

The invention provides a memory searching device and a memory searching method to improve the lookup performance for a memory.

A memory searching device of the invention includes a memory, a lookup command processing circuit, and a lookup result processing circuit. The lookup command processing circuit is coupled to the memory. The lookup command processing circuit receives an original read command string, wherein the original lookup command string includes a plurality of lookup commands for searching the memory. The lookup command processing circuit adjusts an original order of the lookup commands in the original lookup command string to a new order of the lookup commands in a reordered lookup command string based on an access characteristic of the memory. The lookup command processing circuit provides the reordered lookup command string to the memory. The lookup result processing circuit is coupled to the memory to receive a lookup result string corresponding to the reordered lookup command string, wherein the lookup result string includes a plurality of lookup results corresponding to the lookup commands. The lookup result processing circuit is coupled to the lookup command processing circuit to receive mapping information related to the original order and the new order. The lookup result processing circuit restores the new order of the lookup results in the lookup result string to the original order based on the mapping information.

A memory searching method of the invention includes: receiving an original lookup command string, wherein the original lookup command string includes a plurality of lookup commands for searching a memory; adjusting an original order of the lookup commands in an original lookup command string to a new order of the lookup commands in a reordered lookup command string based on an access characteristic of the memory; providing the reordered lookup command string to the memory; receiving a lookup result string corresponding to the reordered lookup command string from the memory, wherein the lookup result string includes a plurality of lookup results corresponding to the lookup commands; and restoring the new order of the lookup results in the lookup result string to the original order based on mapping information related to the original order and the new order.

Based on the above, the memory searching device and the memory searching method of the embodiments of the invention may reorder the lookup commands according to the characteristics of the memory. For example, in the case where the memory is a dynamic random-access memory (DRAM), based on the page size of the DRAM, the address space of the DRAM may be divided into a plurality of access address ranges. Accordingly, the lookup command processing circuit may group a plurality of lookup commands belonging to the same access address range in the lookup commands into the reordered lookup command string (new order). This in turn reduces the number of “close row and open row” in the DRAM. Therefore, the memory searching device may improve the lookup performance for a memory.

In order to make the aforementioned features and advantages of the disclosure more comprehensible, embodiments accompanied with figures are described in detail below.

### BRIEF DESCRIPTION OF THE DRAWINGS

FIG. 1 is a schematic diagram of a circuit block of a memory searching device according to an embodiment of the invention.

FIG. 2 is a schematic diagram of an address space of a memory shown according to an embodiment of the invention.

FIG. 3 is a schematic flowchart of steps of a memory searching method according to an embodiment of the invention.

### DESCRIPTION OF THE EMBODIMENTS

The term “coupled to (or connected to)” used in the entire text of the specification of the present application (including claims) may refer to any direct or indirect connecting means. For example, if the text describes a first device is coupled to (or connected to) a second device, then it should be understood that the first device may be directly connected to the second device, or the first device may be indirectly connected to the second device via other devices or certain connecting means. Terms such as “first” and “second” mentioned in the entire specification of the present application (including the claims) are used to name the elements or to distinguish different embodiments or ranges, and are not used to restrict the upper or lower limits of the number of elements, nor are they used to limit the order of the elements. Moreover, when applicable, elements/components/steps having the same reference numerals in figures and embodiments represent the same or similar parts. Elements/components/steps having the same reference numerals or having the same terminology in different embodiments may be cross-referenced.

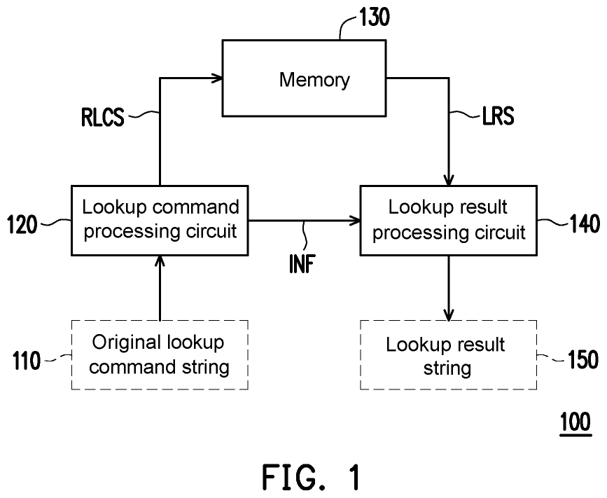

FIG. 1 is a schematic diagram of a circuit block of a memory searching device 100 according to an embodiment of the invention. In the embodiment shown in FIG. 1, the memory searching device 100 includes a memory 130, a lookup command processing circuit 120, and a lookup result processing circuit 140. The lookup command processing circuit 120 is coupled to the memory 130. Based on practical applications, the memory 130 may be any kind of memory. For example, in some embodiments, the memory 130 may include a static random-access memory (SRAM), a dynamic random-access memory (DRAM), a magnetic random-access memory (MRAM), a magnetoresistive random-access memory (MRAM), a flash memory, or other types of memories. Generally speaking, a slower memory usually has more storage space (because of lower cost), and a faster memory usually has less storage space (because of higher cost).

Referring to FIG. 1, the lookup command processing circuit 120 may receive an original lookup command string 110, and then search the memory 130 based on the original lookup command string 110, so that the memory 130 outputs a lookup result string LRS to the lookup result processing circuit 140. The original lookup command string 110 includes a plurality of lookup commands for searching the memory 130. After receiving the original lookup command string 110, the lookup command processing circuit 120 processes the original lookup command string 110. In an embodiment, the lookup command processing circuit 120 may reorder the order (original order) of the lookup commands in the original lookup command string 110 based on an access characteristic of the memory 130 to obtain a new order of the lookup commands. The access characteristic of the memory 130 is described in the following paragraphs. That is, the lookup command processing circuit 120 may adjust the original order of the lookup commands in the original lookup command string 110 to a new order of the lookup commands in a reordered lookup command string RLCS based on the access characteristic of the memory 130. The lookup command processing circuit 120 may provide the reordered lookup command string RLCS to the memory 130. Based on the new order of the lookup commands provided by the lookup command processing circuit 120 (the reordered lookup command string RLCS), the memory 130 may provide the lookup result string LRS corresponding to the reordered lookup command string RLCS to the lookup result processing circuit 140.

The lookup result processing circuit 140 is coupled to the memory 130 to receive the lookup result string LRS corresponding to the reordered lookup command string RLCS. The lookup result string LRS includes a plurality of lookup results corresponding to the lookup commands in the reordered lookup command string RLCS. The lookup result processing circuit 140 is also coupled to the lookup command processing circuit 120 to receive mapping information INF related to the original order of the original lookup command string 110 and the new order of the reordered lookup command string RLCS. The lookup result processing circuit 140 may restore the new order of the lookup results in the lookup result string LRS to the original order based on the mapping information INF to generate a lookup result string 150. Specifically, the lookup result processing circuit 140 may restore the order (that is, the new order of the plurality of lookup commands in the reordered lookup command string RLCS) of the lookup results in the lookup result string LRS to the order (that is, the original order of the plurality of lookup commands in the original lookup command string 110) of the lookup results in the lookup result string 150 according to the mapping information INF.

The following will illustrate with a plurality of embodiments how the lookup command processing circuit 120 adjusts the original order of the lookup commands in the original lookup command string 110 to the new order of the lookup commands in the reordered lookup command string RLCS based on the access characteristic of the memory 130. It should be noted that the following plurality of embodiments may be used as exemplary descriptions of the invention, but should not limit the specific implementation of the invention.

In an embodiment, the lookup command processing circuit 120 may check all of the lookup commands in the original lookup command string 110 to find a plurality of target lookup commands having the same access address from the lookup commands. The lookup command processing circuit 120 replaces the target lookup commands in the lookup commands of the reordered lookup command string RLCS with one representative lookup command of the target lookup commands. The lookup command processing circuit 120 may record the relationship between the target lookup commands and the representative lookup command in the mapping information INF. The lookup result processing circuit 120 may restore one lookup result corresponding to the representative lookup command in the lookup result string LRS to a plurality of lookup results corresponding to the target lookup commands based on the mapping information INF, and then add the restored lookup results to the lookup result string 150.

For example, the lookup command processing circuit 120 may find a plurality of groups of lookup commands (target lookup commands) having the same lookup address from the original lookup command string 110, and keep the first lookup command (representative lookup command) in the lookup commands having the same lookup address in the reordered lookup command string RLCS, and discard the rest of the target lookup commands. The lookup command processing circuit 120 may record the positions of the discarded target lookup commands and the retained representative lookup command in the original lookup command string 110 in the mapping information INF. After the above process, the lookup command processing circuit 120 may generate one “lookup command string that does not repeatedly search for the same address” (the reordered lookup command string RLCS) to the memory 130. The memory 130 generates a unique lookup result (the lookup result string LRS) based on the reordered lookup command string RLCS to the lookup result processing circuit 140.

The lookup result processing circuit 140 may restore/copy the lookup result corresponding to the representative lookup command in the lookup result string LRS to the lookup results corresponding to the target lookup commands in the lookup result string 150 according to the mapping information INF (the positions of the discarded target lookup commands and the retained representative lookup command in the original lookup command string 110).

For example, it is assumed that the original lookup command string 110 has 10 lookup commands, and the access addresses of the lookup commands are 100, 200, 9766, 5, 20, 9113, 9311, 100, 199, 200. The lookup command processing circuit 120 may perform instruction extraction at the same address on the original lookup command string 110 to generate the reordered lookup command string RLCS. In the reordered lookup command string RLCS, the access addresses of the lookup commands are: 100, 200, 9766, 5, 20, 9113, 9311, 199 in sequence. The lookup command processing circuit 120 may record the positions of the discarded target lookup commands and the retained representative lookup command in the original lookup command string 110 in the mapping information INF, as detailed in Table 1 below.

TABLE 1
One example content of the mapping information INF

| New order | Original order | Access address |
|---|---|---|
| 1 | 1 | 100 |
| | 8 | 100 |
| 2 | 2 | 200 |
| | 10 | 200 |
| 3 | 3 | 9766 |
| 4 | 4 | 5 |
| 5 | 5 | 20 |
| 6 | 6 | 9113 |
| 7 | 7 | 9311 |
| 8 | 9 | 199 |

If the memory 130 is searched in the original order shown in Table 1, the lookup operation needs to be performed 10 times. After being reordered by the lookup command processing circuit 120, the memory 130 may be searched in the new order shown in Table 1, so the number of lookup operations is reduced from 10 times to 8 times. The memory 130 provides 8 lookup results (the lookup result string LRS) corresponding to the access addresses “100, 200, 9766, 5, 20, 9113, 9311, 199” to the lookup result processing circuit 140 based on the reordered lookup command string RLCS having the new order shown in Table 1. The lookup result processing circuit 140 may restore/copy the lookup results having the new order shown in Table 1 in the lookup result string LRS to the lookup results having the original order shown in Table 1 in the lookup result string 150 according to the mapping information INF shown in Table 1. The contents of the lookup result string 150 are 10 lookup results corresponding to the access addresses “100, 200, 9766, 5, 20, 9113, 9311, 100, 199, 200” in sequence.

In another embodiment, the access characteristic of the memory 130 includes “when the target address of the memory 130 is accessed, the memory 130 opens the access address range containing the target address”. According to the above access characteristic of the memory 130, the lookup command processing circuit 120 groups the lookup commands belonging to the same access address range in all of the lookup commands of the original lookup command string 110 into a new order (the reordered lookup command string RLCS).

For example, it is assumed that the memory 130 includes a dynamic random-access memory (DRAM). Based on the access characteristic of the page size of the DRAM, the address space of the DRAM may be divided into a plurality of access address ranges. Accordingly, the lookup command processing circuit 120 may group at least one lookup command belonging to the same access address range in the lookup commands of the original lookup command string 110 into a new order (the reordered lookup command string RLCS). This in turn reduces the number of “close row and open row” in the DRAM. Therefore, the memory searching device 100 may improve the lookup performance for the memory 130.

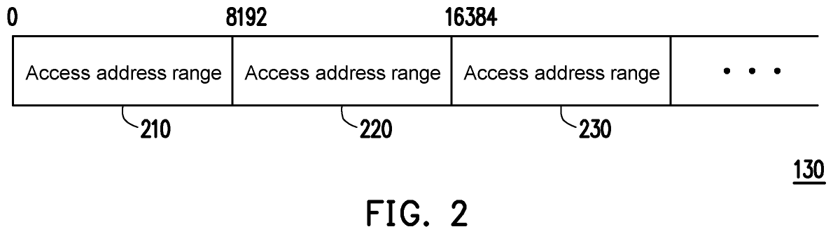

FIG. 2 is a schematic diagram of an address space of the memory 130 shown according to an embodiment of the invention. In the embodiment shown in FIG. 2, the memory 130 is assumed to be dynamic random-access memory (DRAM). Here, it is assumed that the size (page size) of the row buffer of the memory 130 is 8192 bytes. In any case, the page size of the memory 130 may be determined according to actual design. Based on the access characteristic of the page size of the memory 130, the address space of the memory 130 may be divided into a plurality of access address ranges, such as the access address ranges 210, 220, and 230 shown in FIG. 2. The page size of each access address range is 8192 bytes. That is, the access address range 210 is from address 0 to address 8191, the access address range 220 is from address 8192 to address 16383, and the access address range 230 is from address 16384 to address 24575.

For the convenience of description, it is assumed here that the original lookup command string 110 has 10 lookup commands, and the access addresses of the lookup commands are “100, 200, 9766, 5, 20, 9113, 9311, 100, 199, 200”. It is assumed that the lookup command processing circuit 120 does not reorder this original lookup command string 110. The first row of the memory 130 (the access address range 210 from addresses 0 to 8191) is enabled to execute two lookup commands with the access addresses 100 and 200. Since the access address 9766 of the next lookup command is not in the access address range 210, the first row of the memory 130 is closed and the second row (the access address range 220 of addresses 8192 to 16383) is closed to execute the lookup command with access address 9766. By analogy, one “close row and open row” event occurs between access addresses 9766 and 5, between access addresses 20 and 9113, and between access addresses 9311 and 100, respectively. With no reordering at all, the memory 130 has four “close row and open row” events. Each “close row and open row” consumes additional energy.

The lookup command processing circuit 120 may reorder all of the lookup commands of the original lookup command string 110 according to the access address. For example, a plurality of lookup commands belonging to the same access address range in the lookup commands of the original lookup command string 110 are grouped into a new order (the reordered lookup command string RLCS). In the reordered lookup command string RLCS, the access addresses of the lookup commands are: 100, 200, 5, 20, 100, 199, 200, 9766, 9113, 9311 in sequence. The lookup command processing circuit 120 may record the correspondence between the original order of the original lookup command string 110 and the new order of the reordered lookup command string RLCS in the mapping information INF, as detailed in Table 2 below.

TABLE 2
Another example content of the mapping information INF

| New order | Original order | Access address |
|---|---|---|
| 1 | 1 | 100 |
| 2 | 2 | 200 |
| 3 | 4 | 5 |
| 4 | 5 | 20 |
| 5 | 8 | 100 |
| 6 | 9 | 199 |
| 7 | 10 | 200 |
| 8 | 3 | 9766 |
| 9 | 6 | 9113 |
| 10 | 7 | 9311 |

If the memory 130 is searched in the original order shown in Table 2, the memory 130 has four events of “close row and open row”. After being reordered by the lookup command processing circuit 120, the memory 130 may be searched in the new order shown in Table 2, so the number of times of “close row and open row” is reduced from 4 to 1. Therefore, the memory searching device 100 may improve the lookup performance for the memory 130.

The memory 130 provides 10 lookup results (the lookup result string LRS) corresponding to the access addresses “100, 200, 5, 20, 100, 199, 200, 9766, 9113, 9311” to the lookup result processing circuit 140 based on the reordered lookup command string RLCS having the new order shown in Table 2. According to the mapping information INF shown in Table 2, the lookup result processing circuit 140 may restore the lookup results having the new order shown in Table 2 in the lookup result string LRS to the lookup results having the original order shown in Table 2 in the lookup result string 150. The contents of the lookup result string 150 are 10 lookup results corresponding to the access addresses “100, 200, 9766, 5, 20, 9113, 9311, 100, 199, 200” in sequence.

Moreover, in another embodiment, in addition to reordering the original order “100, 200, 9766, 5, 20, 9113, 9311, 100, 199, 200” into “100, 200, 5, 20, 100, 199, 200, 9766, 9113, 9311”, the lookup command processing circuit 120 may further perform instruction extraction at the same address on the reordered “100, 200, 5, 20, 100, 199, 200, 9766, 9113, 9311” to generate the reordered lookup command string RLCS. For the details of “performing instruction extraction at the same address” of the present embodiment, reference may be made to the relevant descriptions in Table 1 above and analogized as such, which is not repeated herein. In the reordered lookup command string RLCS, the access addresses of the lookup commands are: 100, 200, 5, 20, 199, 9766, 9113, 9311 in sequence. The lookup command processing circuit 120 may record the positions of the discarded target lookup commands and the retained representative lookup command in the original lookup command string 110 in the mapping information INF, as detailed in Table 3 below.

TABLE 3
Another example content of the mapping information INF

| New order | Original order | Access address |
|---|---|---|
| 1 | 1 | 100 |
| | 8 | 100 |
| 2 | 2 | 200 |
| | 10 | 200 |
| 3 | 4 | 5 |
| 4 | 5 | 20 |
| 5 | 9 | 199 |
| 6 | 3 | 9766 |
| 7 | 6 | 9113 |
| 8 | 7 | 9311 |

If the memory 130 is searched in the original order shown in Table 3, the lookup operation needs to be performed 10 times. After being reordered by the lookup command processing circuit 120, the memory 130 may be searched in the new order shown in Table 3, so the number of lookup operations is reduced from 10 times to 8 times. In addition, compared with the original order shown in Table 3, the number of times of “close row and open row” of the memory 130 is reduced from 4 times to 1 time.

The memory 130 provides 8 lookup results (the lookup result string LRS) corresponding to the access addresses “100, 200, 5, 20, 199, 9766, 9113, 9311” to the lookup result processing circuit 140 based on the reordered lookup command string RLCS having the new order shown in Table 3. The lookup result processing circuit 140 may restore/copy the lookup results having the new order shown in Table 3 in the lookup result string LRS to the lookup results having the original order shown in Table 3 in the lookup result string 150 according to the mapping information INF shown in Table 3. The contents of the lookup result string 150 are 10 lookup results corresponding to the access addresses “100, 200, 9766, 5, 20, 9113, 9311, 100, 199, 200” in sequence.

In another embodiment, the access characteristic of the memory 130 includes “a plurality of independently accessed memories”. According to the access characteristic of the memory 130, the lookup command processing circuit 120 groups a plurality of lookup commands belonging to different memories in the original lookup command string 110 into the same access batch in the new order.

In an embodiment, the memory 130 includes a plurality of static random-access memories (SRAMs). The lookup command processing circuit 120 groups the plurality of lookup commands belonging to different SRAMs in the plurality of lookup commands of the original lookup command string 110 into the same access batch in the new order (the reordered lookup command string RLCS).

For example, it is assumed that the memory 130 includes a plurality of SRAMs. The quantity of the SRAMs may be determined according to actual design. For the convenience of description, it is assumed here that the memory 130 includes three single-port SRAMs, and each of the three SRAMs may be accessed independently. Single-port means that the SRAM has only one read and write port, that is, one SRAM may only read or write to one address at the same time. As an example, it is assumed here that each SRAM has 8 memory addresses, and the storage space of each address is 64 bytes.

Based on the setting of the memory 130 in the preceding paragraph, in the present embodiment, the access address of each lookup command of the original lookup command string 110 includes two pieces of information: which SRAM and the address within the SRAM. If the access address of the lookup command is recorded as [X, Y], based on the setting of the memory 130 in the preceding paragraph, the value range of X is 0 to 2 (indicating which one of the three SRAMs to be searched), and the value range of Y is 0 to 7 (indicating the SRAM address to be searched).

For example, it is assumed that the original lookup command string 110 has 9 lookup commands, and the access addresses of the lookup commands are “[2, 6], [2, 1], [2, 4], [2, 0], [1, 3], [1, 1], [0, 7], [0, 5], [1, 4]”. Without reordering the original lookup command string 110, the memory 130 performs nine read operations. The lookup command processing circuit 120 may perform a grouping operation (reordering) on the access addresses “[2, 6], [2, 1], [2, 4], [2, 0], [1, 3], [1, 1], [0, 7], [0, 5], [1, 4]” in the original lookup command string 110 to aggregate a plurality of lookup commands belonging to different SRAMs into the same access batch. Specifically, the original order of the original lookup command string 110 is converted into the new order of the reordered lookup command string RLCS, that is, “[2, 6], [1, 3], [0, 7], [2, 1], [1, 1], [0, 5], [2, 4], [1, 4], [2, 0]”, wherein “[2, 6], [1, 3], [0, 7]” are the first access batch, “[2, 1], [1, 1], [0, 5]” are the second access batch, “[2, 4], [1, 4]” are the third access batch, and “[2, 0]” is the fourth access batch. Since each SRAM has the characteristic of being accessed independently, a plurality of SRAMs may be accessed at the same time in each access batch. When the original lookup command string 110 is reordered by the lookup command processing circuit 120, the memory 130 performs four read operations.

The lookup command processing circuit 120 may record the correspondence between the original order of the original lookup command string 110 and the new order of the reordered lookup command string RLCS in the mapping information INF, as detailed in Table 4 below.

TABLE 4
Another example content of the mapping information INF

| New order | Original order | Access address |
|---|---|---|
| 1 | 1 | [2, 6] |
| | 5 | [1, 3] |
| | 7 | [0, 7] |
| 2 | 2 | [2, 1] |
| | 6 | [1, 1] |
| | 8 | [0, 5] |
| 3 | 3 | [2, 4] |
| | 9 | [1, 4] |
| 4 | 4 | [2, 0] |

If the memory 130 is searched in the original order shown in Table 4, the memory 130 performs nine read operations. After being reordered by the lookup command processing circuit 120, the memory 130 may be searched in the new order shown in Table 4, so the number of read operations (the number of access batches) of the memory 130 is reduced from nine to four. Therefore, the memory searching device 100 may improve the lookup performance for the memory 130.

In any embodiment above, after converting the original lookup command string 110, the lookup command processing circuit 120 generates corresponding restoration information (the mapping information INF) to the lookup result processor 140 at the same time. The lookup result processor 140 may restore the lookup result string LRS output by the memory 130 to the lookup result string 150 according to the restoration information.

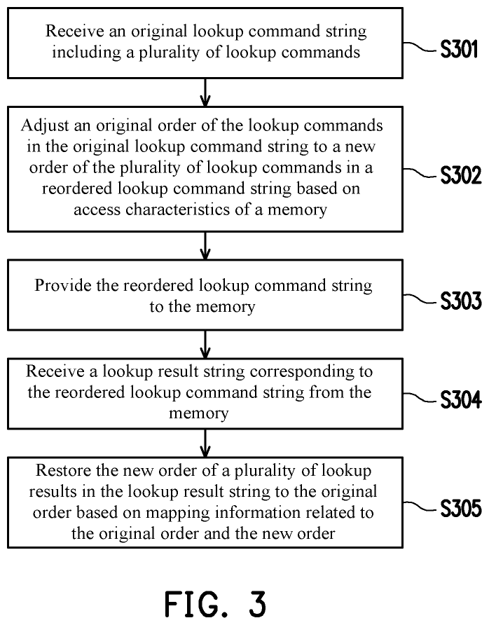

FIG. 3 is a schematic flowchart of steps of a memory searching method according to an embodiment of the invention. Please refer to FIG. 1 and FIG. 3. In step S301, the lookup command processing circuit 120 receives the original lookup command string 110 including a plurality of lookup commands. In step S302, the lookup command processing circuit 120 adjusts the original order of the lookup commands in the original lookup command string 110 to a new order of the plurality of lookup commands in the reordered lookup command string RLCS based on the access characteristic of the memory 130. In step S303, the lookup command processing circuit 120 provides the reordered lookup command string RLCS to the memory 130. In step S304, the lookup result processor 140 receives the lookup result string LRS corresponding to the reordered lookup command string RLCS from the memory. In step S305, the lookup result processor 140 restores the new order of the plurality of lookup results in the lookup result string LRS to the original order of the lookup results in the lookup result string 150 based on the mapping information INF related to the original order and the new order.

According to different design requirements, in some embodiments, the implementation of the lookup command processing circuit 120 and/or the lookup result processing circuit 140 may be a hardware circuit. In some other embodiments, the implementation of the lookup command processing circuit 120 and/or the lookup result processing circuit 140 may be firmware, software (i.e., program), or a combination of the two. In some other embodiments, the implementation of the lookup command processing circuit 120 and/or the lookup result processing circuit 140 may be a combination of a plurality of hardware, firmware, and software.

In terms of hardware, the lookup command processing circuit 120 and/or the lookup result processing circuit 140 may be implemented as a logic circuit on an integrated circuit. For example, the related functions of the lookup command processing circuit 120 and/or the lookup result processing circuit 140 may be implemented in one or a plurality of controllers, microcontrollers, microprocessor, application-specific integrated circuits (ASICs), digital signal processors (DSPs), field-programmable gate arrays (FPGAs), and/or various logic blocks, modules, and circuits in other processing units. The related functions of the lookup command processing circuit 120 and/or the lookup result processing circuit 140 may be implemented as hardware circuits using hardware description languages (such as Verilog HDL or VHDL) or other suitable programming languages, such as various logic blocks, modules, and circuits in an integrated circuit.

In the form of software and/or firmware, the related functions of the lookup command processing circuit 120 and/or the lookup result processing circuit 140 may be implemented as a programming code. For example, the lookup command processing circuit 120 and/or the lookup result processing circuit 140 are implemented using general programming languages (e.g., C, C++, or assembly language) or other suitable programming languages. The programming code may be recorded/stored in a “non-transitory computer-readable medium”. In some embodiments, the non-transitory computer-readable medium includes, for example, a semiconductor memory and/or a storage device. The semiconductor memory includes a memory card, a read-only memory (ROM), a flash memory, a programmable logic circuit, or other semiconductor memories. The storage device includes a tape, a disk, a hard disk drive (HDD), a solid-state drive (SSD), or other storage devices. An electronic equipment (such as a central processing unit (CPU), controller, microcontroller, or microprocessor) may read and execute the programming code from the non-transitory computer-readable medium to implement the related functions of the lookup command processing circuit 120 and/or the lookup result processing circuit 140. Alternatively, the programming code may be provided to the electronic equipment via any transmission medium (e.g., a communication network or broadcast waves, etc.) The communication network is, for example, the Internet, a wired communication network, a wireless communication network, or other communication media.

Based on the above, the memory searching device 100 and the memory searching method of the above embodiments may reorder all lookup commands of the original lookup command string 110 according to the characteristics of the memory 130. For example, in the case where the memory 130 is a DRAM, based on the page size of the DRAM, the address space of the DRAM may be divided into a plurality of access address ranges. Accordingly, the lookup command processing circuit 120 may group a plurality of lookup commands belonging to the same access address range in the lookup commands into the reordered lookup command string RLCS (new order). This in turn reduces the number of “close row and open row” in the DRAM. In the case where the memory 130 is a plurality of SRAMs, each of the SRAMs may be accessed independently. The lookup command processing circuit 120 may group the plurality of lookup commands belonging to different SRAMs in the plurality of lookup commands of the original lookup command string 110 into the same access batch in the new order (the reordered lookup command string RLCS) to further reduce the number of read operations to the memory 130. Therefore, the memory searching device may improve the lookup performance for a memory and reduce power consumption.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A memory searching device, comprising:
a memory;
a lookup command processing circuit coupled to the memory, wherein the lookup command processing circuit receives an original lookup command string, the original lookup command string comprises a plurality of lookup commands for searching the memory, the lookup command processing circuit adjusts an original order of the lookup commands in the original lookup command string to a new order of the lookup commands in a reordered lookup command string based on an access characteristic of the memory, and the lookup command processing circuit provides the reordered lookup command string to the memory; and
a lookup result processing circuit coupled to the memory to receive a lookup result string corresponding to the reordered lookup command string, and coupled to the lookup command processing circuit to receive mapping information related to the original order and the new order, wherein the lookup result string comprises a plurality of lookup results corresponding to the lookup commands, and the lookup result processing circuit restores the new order of the lookup results in the lookup result string to the original order based on the mapping information.

2. The memory searching device of claim 1, wherein the lookup command processing circuit checks the lookup commands in the original lookup command string to find a plurality of target lookup commands having a same access address from the lookup commands, the lookup command processing circuit replaces the target lookup commands in the lookup commands of the reordered lookup command string with one representative lookup command of the target lookup commands, the lookup command processing circuit records a relationship between the target lookup commands and the representative lookup command in the mapping information, and the lookup result processing circuit restores a lookup result corresponding to the representative lookup command in the lookup result string to a plurality of lookup results corresponding to the target lookup commands based on the mapping information.

3. The memory searching device of claim 1, wherein the access characteristic comprises “when a target address of the memory is accessed, the memory opens an access address range containing the target address”, and the lookup command processing circuit groups at least one lookup command belonging to a same access address range in the lookup commands in the new order.

4. The memory searching device of claim 1, wherein the memory comprises a dynamic random-access memory, an address space of the dynamic random-access memory is divided into a plurality of access address ranges based on a page size of the dynamic random-access memory, and the lookup command processing circuit groups at least one lookup command belonging to a same access address range in the lookup commands in the new order.

5. The memory searching device of claim 1, wherein the access characteristic comprises “a plurality of independently accessed memories”, and the lookup command processing circuit groups a plurality of lookup commands belonging to different memories in the lookup commands into a same access batch in the new order.

6. The memory searching device of claim 1, wherein the memory comprises a plurality of static random-access memories, and the lookup command processing circuit groups a plurality of lookup commands belonging to different static random-access memories in the lookup commands into a same access batch in the new order.

7. A memory searching method, comprising:
receiving an original lookup command string, wherein the original lookup command string comprises a plurality of lookup commands for searching a memory;
adjusting an original order of the lookup commands in the original lookup command string to a new order of the lookup commands in a reordered lookup command string based on an access characteristic of the memory;
providing the reordered lookup command string to the memory;
receiving a lookup result string corresponding to the reordered lookup command string from the memory, wherein the lookup result string comprises a plurality of lookup results corresponding to the lookup commands; and
restoring the new order of the lookup results in the lookup result string to the original order based on mapping information related to the original order and the new order.

8. The memory searching method of claim 7, further comprising:
checking the lookup commands in the original lookup command string to find a plurality of target lookup commands having a same access address from the lookup commands;
replacing the target lookup commands in the lookup commands of the reordered lookup command string with one representative lookup command of the target lookup commands;
recording a relationship between the target lookup commands and the representative lookup command in the mapping information; and
restoring a lookup result corresponding to the representative lookup command in the lookup result string to a plurality of lookup results corresponding to the target lookup commands based on the mapping information.

9. The memory searching method of claim 7, wherein the access characteristic comprises “when a target address of the memory is accessed, the memory opens an access address range containing the target address”, and the memory searching method further comprises:
grouping at least one lookup command belonging to a same access address range in the lookup commands in the new order.

10. The memory searching method of claim 7, wherein the memory comprises a dynamic random-access memory, and the memory searching method further comprises:
dividing an address space of the dynamic random-access memory into a plurality of access address ranges based on a page size of the dynamic random-access memory; and
grouping at least one lookup command belonging to a same access address range in the lookup commands in the new order.

11. The memory searching method of claim 7, wherein the access characteristic comprises “a plurality of independently accessed memories”, and the memory searching method further comprises:
grouping a plurality of lookup commands belonging to different memories in the lookup commands into a same access batch in the new order.

12. The memory searching method of claim 7, wherein the memory comprises a plurality of static random-access memories, and the memory searching method further comprises:
grouping a plurality of lookup commands belonging to different static random-access memories in the lookup commands into a same access batch in the new order.
